(19) United States
(12) Patent Application Publication
(10) Pub. No.: US 2026/0259902 A1
(43) Pub. Date: Sep. 3, 2026

(54) SYSTEMS, METHODS, AND APPARATUS FOR A HYBRID SOCIAL-ARTIFICIAL-INTELLIGENCE INTERACTION PLATFORM WITH AXIOM-LOCKED RETRIEVAL, REAL-TIME VOICE DUPLEX, FIDELITY VALIDATION, AND IN-FEED MULTIMODAL CONTENT GENERATION

(71) Applicant: CHUANPING HU, Pittsburg, KS (US)

(72) Inventor: CHUANPING HU, Pittsburg, KS (US)

(21) Appl. No.: 19/651,648

(22) Filed: Apr. 18, 2026

(51) Int. Cl. G06F 16/3329; G10L 13/08

(52) U.S. Cl. CPC G06F 16/33295; G10L 13/08

(57) ABSTRACT

A hybrid social-artificial-intelligence interaction platform is disclosed in which a user remains inside an active social session while invoking artificial-intelligence assistance, receiving a response grounded in an authoritative corpus, and converting the validated response into a publishable social artifact without leaving the session. The platform includes a social session manager, an invocation interface, an input processor for text and speech, a corpus store, a retrieval controller, a response-generation engine, a fidelity validator, an output renderer, and a multimodal publishing pipeline. Embodiments support real-time speech transcription, synchronized text-to-speech playback, simplified-language rendering, one-click generation of posts or short videos, provenance logging, offline caching, dashboard guidance, and safety or compliance indicators. The disclosed architecture reduces context switching, improves answer trustworthiness, and accelerates social publication of validated AI-assisted content.

### BACKGROUND OF THE INVENTION

### Field of the Invention

The present invention relates generally to social computing, human-computer interaction, large-language-model orchestration, retrieval-augmented generation, multimodal publishing, and voice-enabled user interfaces. More particularly, the invention relates to systems, methods, and apparatus for integrating an artificial-intelligence response system directly into a social application such that a user may ask questions, receive validated responses, and publish AI-assisted output without leaving an active social interaction context.

### Description of the Related Art

Conventional social applications and conventional artificial-intelligence applications remain structurally separate. A user commonly discovers a post, video, or message in a social application, exits or context-switches to a separate chatbot or search tool, reformulates a question, obtains an answer of uncertain provenance, and then manually returns to the original social application to post or share content. This fragmentation imposes high cognitive load, increases context loss, and particularly burdens elderly, low-literacy, or non-technical users.

Existing social applications may provide recommendation engines, search bars, or limited assistant functions, but they do not provide a persistent, in-context, corpus-locked question-and-answer architecture that remains continuously available across feed browsing, short-video consumption, chat, groups, live-stream participation, and post creation. Existing chatbot products, by contrast, may provide strong conversational capability, but they are typically detached from social publishing flow, do not preserve in-feed continuity, and often generate responses without a dedicated fidelity-verification stage against an authoritative bounded knowledge corpus.

Further, when AI-generated content is created in separate applications, publication back into a social environment usually requires copying, editing, exporting, and re-uploading. This multi-step process slows user engagement, weakens viral spread, and causes mismatch between the original question, the authoritative answer, and the final published artifact.

There remains a need for a unified platform that: (i) embeds AI interaction directly within the social session, (ii) retrieves and generates from an authoritative bounded corpus, (iii) validates answer faithfulness before output, (iv) supports voice-first interaction for ordinary users, and (v) converts answers into publishable multimodal artifacts with one or a few actions.

### BRIEF SUMMARY OF THE INVENTION

The present invention provides a hybrid social-artificial-intelligence interaction platform that seamlessly combines social networking functionality with a dedicated AI response engine tied to an authoritative corpus.

In one aspect, the invention provides a system comprising: (a) a social session manager configured to maintain a user within an active social context selected from a feed, short-video interface, chat session, group interface, live stream, story interface, event page, or comment thread; (b) an AI invocation interface comprising an always-available interaction control accessible without leaving the active social context; (c) an input processor configured to receive a user query in text, speech, or mixed modality; (d) an axiom corpus store containing an authoritative knowledge corpus; (e) a retrieval controller configured to retrieve one or more corpus segments responsive to the user query; (f) a response-generation engine configured to generate a candidate response based on at least the user query and the retrieved corpus segments; (g) a fidelity validator configured to determine whether the candidate response satisfies one or more faithfulness constraints relative to the authoritative corpus; (h) an output renderer configured to render a validated response as text, speech, graphical cards, dashboards, action lists, subtitles, or other user-consumable output; and (i) a multimodal publishing pipeline configured to transform at least part of the validated response into a publishable social artifact within the same application.

In another aspect, the invention provides a method by which a user, while remaining inside a social interface, invokes an AI assistant, receives an answer validated against an authoritative corpus, and converts that answer into a post, message, or video without leaving the active session.

In another aspect, the invention provides embodiments optimized for elderly and low-literacy users by including real-time speech transcription, simplified-language response rendering, text-to-speech playback with repeat and speed controls, full-duplex voice exchange, enlarged controls, and optionally a wake phrase for hands-free invocation.

In another aspect, the invention provides a technical improvement to human-computer interaction by reducing context switching between social and AI applications, preserving session continuity, reducing user cognitive overhead, and improving the reliability of generated content through bounded retrieval and fidelity validation before publication.

In another aspect, the invention provides an extensible platform in which validated answers may be transformed automatically into multiple content formats, including a short social post, a long-form explanation, a share card, a chat reply, a narrated short video, a subtitle package, or a live-stream response overlay.

### BRIEF DESCRIPTION OF THE DRAWINGS

FIG. 1 is a high-level block diagram of the hybrid social-artificial-intelligence interaction platform.

FIG. 2 is a user-interface flow diagram showing a user scrolling a feed, invoking an AI assistant through a persistent floating control, asking a question, receiving an answer, and publishing a derived artifact without leaving the active session.

FIG. 3 is a pipeline diagram showing query intake, corpus retrieval, candidate generation, fidelity validation, response rendering, and publishing transformation.

FIG. 4 is a voice-first interaction diagram including speech capture, streaming transcription, response generation, text-to-speech playback, replay control, and wake-phrase re-entry.

FIG. 5 is a multimodal publishing diagram showing transformation of a validated response into a post, message, short video, card, or live-stream overlay.

FIG. 6 is a personalized dashboard and safety-compliance diagram showing one or more status indicators, guidance cards, action buttons, and an axiom compliance badge.

FIG. 7 is a data-structure diagram illustrating a query object, retrieved corpus segments, validation metadata, response object, publish package, and provenance log entries.

### DETAILED DESCRIPTION OF THE INVENTION

### I. Introduction and Definitions

The present invention is directed to a comprehensive platform for hybrid social and artificial-intelligence interaction. The invention uniquely integrates a social application front end with an authoritative-corpus retrieval system, a response generation system, a fidelity-verification system, and an in-session content-publication system.

As used herein, the term “social session” means any user interaction state in which a user is browsing, consuming, creating, reacting to, or communicating through social content, including but not limited to scrolling a feed, watching a short video, entering a comment thread, participating in a chat, joining a group, or viewing a live stream.

As used herein, the term “authoritative axiom corpus” means a bounded corpus designated by the system as an authoritative source for at least one operating mode of response generation.

As used herein, the term “fidelity validation” means a post-generation or concurrent verification process by which a candidate response is evaluated for support, consistency, traceability, or contradiction relative to the authoritative axiom corpus.

As used herein, the term “in-feed” means that the user remains in the current social interface without forced navigation to a separate application or a separate primary interaction workspace.

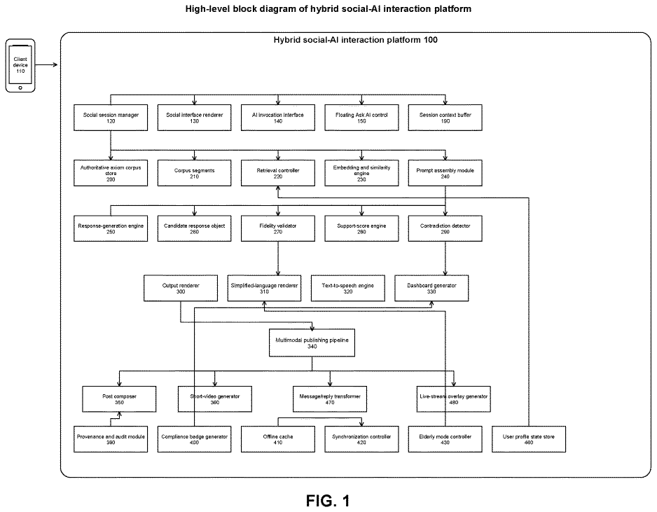

### II. System Overview (FIG. 1)

Referring to FIG. 1, the hybrid social-AI interaction platform 100 comprises one or more client devices 110 communicating with one or more servers or cloud components implementing the social session manager 120, social interface renderer 130, AI invocation interface 140, authoritative axiom corpus store 200, retrieval controller 220, response-generation engine 250, fidelity validator 270, output renderer 300, multimodal publishing pipeline 340, and provenance and audit module 390.

The social session manager 120 maintains a current user session state including the active interface, visible content, active thread or feed position, active contacts or group membership, and recently observed user interactions. The session context buffer 190 stores at least part of the current UI context so that a user may invoke AI assistance without losing session continuity.

The AI invocation interface 140 presents a persistent or selectively persistent interaction entry point, such as floating Ask AI control 150, bottom toolbar control, swipe gesture, long-press region, or voice activation. In preferred embodiments, the user may invoke AI assistance during feed scrolling, video playback, chat, or live-stream participation.

The authoritative axiom corpus store 200 contains a bounded knowledge base used in at least one operating mode as the sole or primary source of truth. The corpus may be divided into corpus segments 210, each of which may be tagged by topic, priority, confidence level, language, audience type, or usage scope.

The retrieval controller 220 receives a parsed query and uses embedding and similarity engine 230 to identify relevant corpus segments 210. In some embodiments, the retrieval controller applies lexical retrieval, semantic retrieval, or hybrid retrieval. The retrieval controller may also use session context, user profile attributes from user profile state store 460, language preference, or active social-context metadata to refine retrieval.

Prompt assembly module 240 constructs a structured prompt for response-generation engine 250. The prompt may include one or more retrieved corpus segments, one or more operating instructions, one or more formatting directives, one or more safety directives, and one or more audience-adaptation settings.

The response-generation engine 250 produces a candidate response object 260 based on the structured prompt and one or more retrieved corpus segments. Candidate response object 260 may include plain text, structured bullet output, a JSON response, a script outline, a card layout instruction, a video storyboard instruction, or a speech-oriented answer.

The fidelity validator 270 examines candidate response object 260 before final delivery. In one embodiment, support-score engine 280 determines whether propositions in candidate response object 260 are sufficiently supported by retrieved corpus segments 210. In another embodiment, contradiction detector 290 determines whether candidate response object 260 contradicts retrieved corpus segments 210 or one or more protected system constraints. The fidelity validator 270 may then approve, reject, revise, annotate, or confidence-score the candidate response.

Output renderer 300 displays the validated response within the active social session. The response may be rendered as plain text, synchronized text plus audio, a visual card, a dashboard, a step list, a choice flow, a reply suggestion, a summary, or a structured plan. Dashboard generator 330 may convert the validated response into one or more user-facing visual indicators.

The multimodal publishing pipeline 340 transforms a validated response into a publishable social artifact without requiring the user to leave the social application. The publishable artifact may be sent to post composer 350, short-video generator 360, message/reply transformer 470, or live-stream overlay generator 480.

The provenance and audit module 390 stores information sufficient to reconstruct at least part of the AI-assisted content-generation process. Compliance badge generator 400 may generate a visible indicator showing that the output passed one or more corpus-fidelity or system-compliance checks.

Offline cache 410 stores selected corpus fragments, query templates, prior validated responses, or user-preferred guidance bundles. Synchronization controller 420 uploads queued audit entries and publication events when connectivity returns.

For users with limited literacy, low digital familiarity, or age-related accessibility needs, elderly mode controller 430 applies one or more adaptations. Simplified-language renderer 310 transforms output into a readability-adjusted format. Text-to-speech engine 320 provides spoken output.

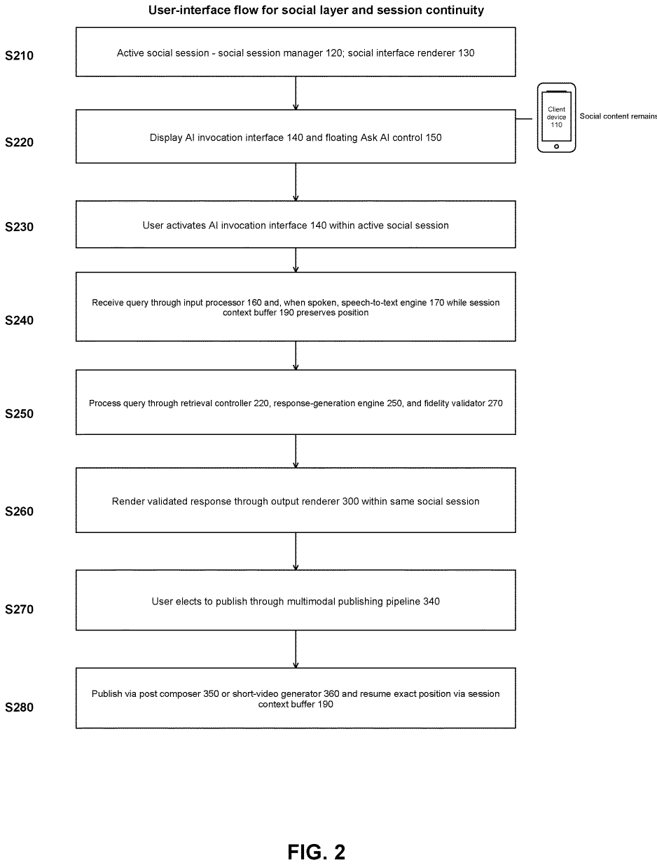

### III. Social Layer and Session Continuity (FIG. 2)

Referring now to FIG. 2, a user-interface flow diagram illustrates how a user interacts with the hybrid social-AI interaction platform 100 while remaining within a continuous social session. The process begins with the user operating a client device 110 that displays a social interface rendered by social interface renderer 130.

In step S210, the user is engaged in an active social session managed by social session manager 120. The social interface may take any of the forms enumerated in the definition of “social session,” such as scrolling a vertical short-video feed, browsing a real-time discussion feed, participating in a private chat or group chat, reading or composing comments in a comment thread, viewing a story, or watching a live stream.

In step S220, while the user remains within the active social session, the system displays an AI invocation interface 140 that is persistently available. In the preferred embodiment shown, the AI invocation interface 140 takes the form of a floating Ask AI control 150 that overlays the social interface content. The floating Ask AI control 150 is designed to be unobtrusive yet readily accessible, allowing the user to invoke artificial-intelligence assistance with a single tap, click, or voice command, without navigating away from the current social view. The session context buffer 190 continuously preserves the user's position within the social session (e.g., scroll position in a feed, playback timestamp in a video, or active message thread).

In step S230, the user activates the AI invocation interface 140, for example by tapping the floating Ask AI control 150. In response, the system presents an interaction overlay, a split-pane interface, or an expandable drawer that coexists with the underlying social interface. Critically, the user is not redirected to a separate application or a distinct primary workspace; the social session remains active and visible beneath or adjacent to the newly presented AI interaction region.

In step S240, the user inputs a query using the input processor 160. The query may be entered as text via a keyboard or, in preferred embodiments, as speech captured by a microphone and transcribed in real time by speech-to-text engine 170. The user's query is received while the social interface content remains visible in the background, and the session context buffer 190 may augment the query with contextual metadata, such as the identity of a post that was on-screen at the time of invocation.

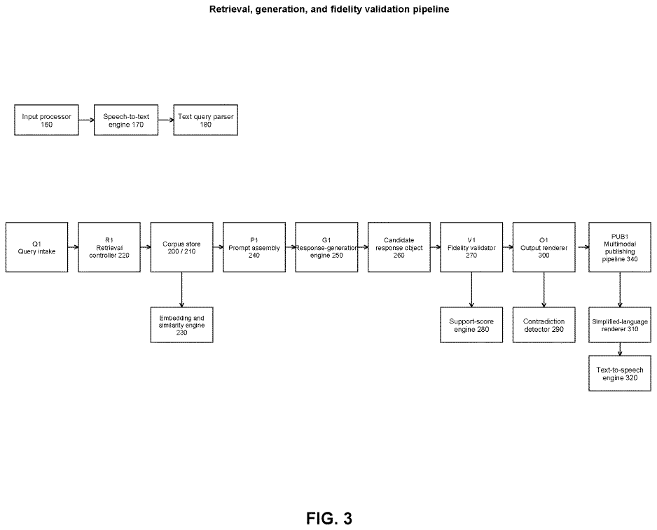

In step S250, the system processes the query through the retrieval controller 220, response-generation engine 250, and fidelity validator 270 to produce a validated response. This internal pipeline is described in greater detail with reference to FIG. 3.

In step S260, the output renderer 300 presents the validated response to the user within the same interaction overlay or panel. The response may be rendered as text, spoken output via text-to-speech engine 320, graphical cards generated by dashboard generator 330, or a combination thereof. The user may interact with the response (e.g., ask a follow-up question, request clarification, replay spoken output) without losing the underlying social session context.

In step S270, the user elects to share or publish content derived from the validated response. The multimodal publishing pipeline 340 transforms at least a portion of the validated response into a publishable social artifact. For instance, the user may tap a “Post” button, causing post composer 350 to create a feed post; or the user may tap a “Create Video” button, causing short-video generator 360 to automatically produce a narrated short video based on the response content.

In step S280, the publishable social artifact is posted to the user's social feed, shared in a chat, added to a story, or otherwise disseminated through the social session manager 120. Throughout this entire process, the user has not been forced to exit the active social session or manually context-switch between applications. After publishing, the user may dismiss the AI interaction overlay and immediately resume the social session at the exact position preserved by session context buffer 190.

### IV. Retrieval, Generation, and Fidelity Validation Pipeline (FIG. 3)

Referring now to FIG. 3, a pipeline diagram illustrates the flow of data and processing operations from query intake through response validation and publication. The pipeline may be executed on one or more servers, on the client device 110 in a hybrid or on-device configuration, or in a distributed cloud environment.

The process begins with query intake Q1. A user query is received via input processor 160. If the query is spoken, speech-to-text engine 170 converts the audio signal into text. Text query parser 180 normalizes the text, corrects typographical errors if appropriate, and may segment the query into discrete semantic components. The parsed query is then passed to retrieval controller 220.

At retrieval stage R1, the retrieval controller 220 interacts with authoritative axiom corpus store 200. The retrieval controller 220 employs embedding and similarity engine 230 to generate a vector representation of the parsed query and to identify one or more corpus segments 210 that are semantically relevant. In some embodiments, lexical retrieval, semantic retrieval, or hybrid retrieval techniques are applied. The retrieval controller 220 may also consider session context stored in session context buffer 190, user profile attributes from user profile state store 460, language preferences, or other metadata to refine the retrieval. The output of retrieval stage R1 is a set of one or more retrieved corpus segments 210.

At prompt assembly stage P1, prompt assembly module 240 constructs a structured input for the response-generation engine 250. The structured prompt includes at least the user's original or parsed query and the retrieved corpus segments 210. Additionally, the prompt may include system instructions that dictate the desired format, tone, audience adaptation (e.g., simplified language), safety constraints, and a directive to generate responses strictly derivable from the provided corpus segments.

At generation stage G1, response-generation engine 250 processes the structured prompt and produces a candidate response object 260. The response-generation engine 250 may be a large language model (LLM) or any other suitable generative model. Candidate response object 260 is not yet displayed to the user; it is an intermediate data structure containing the generated text, formatting metadata, and optionally structured output such as JSON for cards or dashboards.

At fidelity validation stage V1, fidelity validator 270 evaluates candidate response object 260. In a preferred embodiment, the fidelity validator 270 comprises two sub-modules: support-score engine 280 and contradiction detector 290. Support-score engine 280 computes a metric indicating the degree to which each proposition in the candidate response is supported by the retrieved corpus segments 210 or the broader authoritative axiom corpus store 200. Contradiction detector 290 identifies any statements in the candidate response that directly conflict with the authoritative axiom corpus. Based on the outputs of support-score engine 280 and contradiction detector 290, the fidelity validator 270 makes a determination to approve, reject, revise, annotate, or assign a confidence score to the candidate response.

If the candidate response passes validation (decision D1), it becomes a validated response and proceeds to output rendering stage O1. If it fails validation, the system may take remedial action, such as triggering a re-generation request with stricter constraints, applying automatic revision to remove unsupported claims, or returning a graceful failure message indicating that a faithful answer could not be generated from the authoritative corpus.

At output rendering stage O1, output renderer 300 prepares the validated response for presentation to the user. This may involve converting plain text into a visually formatted card, invoking simplified-language renderer 310 for low-literacy modes, or passing the text to text-to-speech engine 320 for spoken output. The rendered response is then displayed to the user within the active social session.

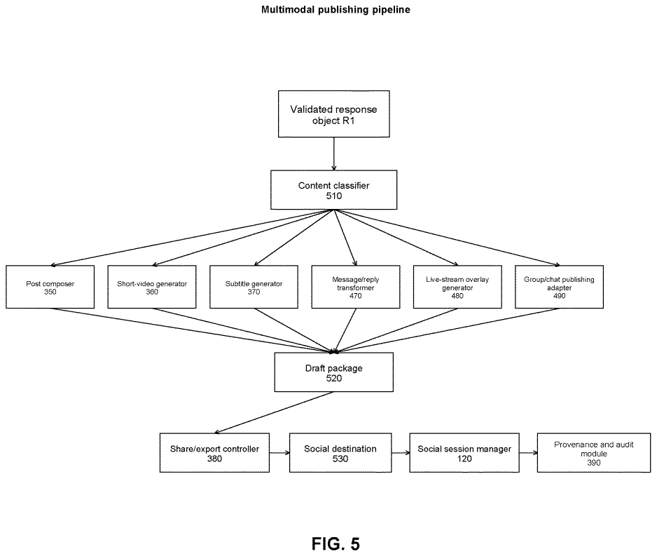

Finally, at publishing stage PUB1, if the user elects to publish content based on the validated response, the multimodal publishing pipeline 340 transforms the validated response into one or more publishable social artifacts. This stage may involve post composer 350, short-video generator 360, subtitle generator 370, or other components described in greater detail with reference to FIG. 5.

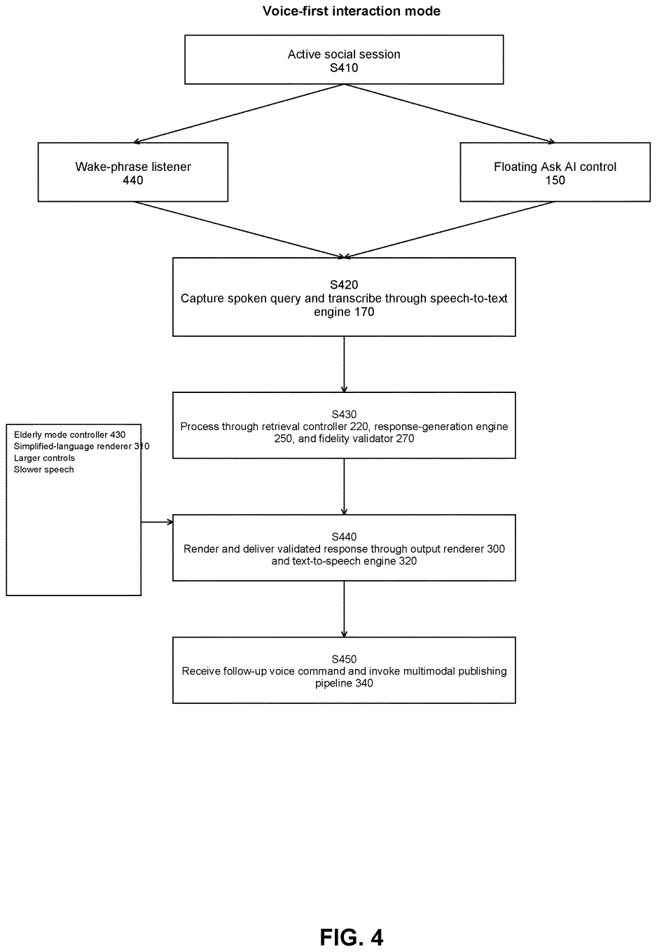

### V. Voice-First Interaction Mode (FIG. 4)

Referring now to FIG. 4, a voice-first interaction diagram illustrates an embodiment particularly suited for elderly users, low-literacy users, or any user who prefers hands-free operation. This mode leverages the voice interaction controller and related components to provide a seamless spoken dialogue within the social session.

The process begins at step S410, where the user is engaged in an active social session. While scrolling a feed, watching a video, or participating in a chat, the user may speak a wake phrase detected by wake-phrase listener 440. The wake phrase (e.g., “Hey H App”) signals the system to prepare for voice input without requiring the user to touch the screen. Alternatively, the user may tap the floating Ask AI control 150 to manually initiate voice input.

At step S420, the user speaks a natural-language query. The speech is captured by a microphone on client device 110 and streamed to speech-to-text engine 170. In a preferred embodiment, speech-to-text engine 170 performs real-time streaming transcription, and incremental transcription may be displayed on the screen as the user speaks, providing immediate feedback.

At step S430, the transcribed query is processed through the pipeline described in FIG. 3 (retrieval, generation, fidelity validation). The response-generation engine 250 produces a validated response, which is passed to output renderer 300.

At step S440, the validated response is delivered to the user via text-to-speech engine 320 as spoken output. Simultaneously, the synchronized text of the response may be displayed on the screen. The voice interaction controller is configured to support continuous duplex or semi-duplex interaction, meaning the user can interrupt, pause, replay, or adjust the speed of the spoken output. For example, the user may say “pause” or “say that again,” or may tap a replay button on the screen to hear the response repeated. Variable-speed playback allows users to slow down the speech for better comprehension.

At step S450, after listening to the spoken response, the user may issue a follow-up voice command. For example, the user may say “post that to my feed” or “send that as a reply.” In response, the multimodal publishing pipeline 340 converts the validated response into the requested publishable social artifact, and the system may provide spoken confirmation, such as “Posted to your feed.”

For users operating in an elderly mode controlled by elderly mode controller 430, the system may automatically apply additional adaptations during this voice-first interaction. These adaptations include enlarged on-screen controls for replay and pause, high-contrast visual themes, simplified-language output via simplified-language renderer 310, slower default speech rate, and automatic repetition of the spoken response if no user input is detected within a timeout period. The system may also proactively offer a spoken prompt such as “Would you like me to repeat that?” or “Would you like to share this answer?”

This voice-first interaction mode significantly reduces the cognitive and physical barriers to accessing AI assistance, enabling users who may be uncomfortable with typing or complex touch interfaces to benefit fully from the axiom-locked guidance provided by the platform, all while remaining within their familiar social application environment.

### VI. Multimodal Publishing Pipeline (FIG. 5)

Referring now to FIG. 5, a detailed diagram of the multimodal publishing pipeline 340 is shown. The pipeline receives a validated response from the output renderer 300 or directly from the fidelity validator 270 and transforms it into one or more publishable social artifacts that can be disseminated within the same application session without requiring the user to manually copy, edit, or export content.

The pipeline begins with a validated response object R1, which contains the text, structured data, formatting metadata, and optionally media generation instructions derived from the candidate response object 260 after passing fidelity validation.

The validated response object R1 is first routed to a content classifier 510, which analyzes the content to determine the most suitable publication formats. The content classifier 510 may consider factors such as the length of the response, the presence of structured data (e.g., bullet points, numbered steps, tabular information), the inferred user intent (e.g., whether the response answers a factual question, provides a plan, or offers guidance), and explicit user preferences.

Based on the classification, the validated response is directed to one or more transformation modules. In the embodiment shown, the pipeline includes post composer 350, short-video generator 360, subtitle generator 370, message/reply transformer 470, live-stream overlay generator 480, and group or chat publishing adapter 490. Each of these modules produces a different type of publishable social artifact.

The post composer 350 generates a social media post suitable for a feed or story. This may be a short text post with an optional attached card, a longer article-style post, or a shareable image card containing a summary of the response. The post composer 350 may also apply axiom-based quality filtering to ensure that the content promoted to the public feed aligns with the authoritative corpus and meets quality thresholds.

The short-video generator 360 automatically produces a short-form video (e.g., 15 to 60 seconds in duration) based on the validated response. The video generation process includes: generating a narration script from the response text; synthesizing a voiceover using text-to-speech engine 320; selecting or generating background visuals (e.g., animated text, relevant stock imagery, graphical cards generated by dashboard generator 330); and assembling the components into a video file. Subtitle generator 370 may automatically create closed captions or burned-in subtitles for the video, ensuring accessibility.

The message/reply transformer 470 converts the validated response into a format suitable for private messages or chat replies. This may involve truncating the response for brevity, formatting it as a threaded reply, or adding a “sent via AI” badge.

The live-stream overlay generator 480 produces an overlay graphic or text that can be displayed during a live broadcast, allowing a streamer to share AI-generated insights with their audience in real time.

The group or chat publishing adapter 490 formats the content for group discussions, ensuring compatibility with group-specific formatting and notification settings.

Each transformation module outputs a publishable artifact, which is temporarily stored as a draft package 520. The draft package 520 is presented to the user via a preview interface generated by share/export controller 380. The user may view a visual preview of the AI-generated content before publication, edit the content if desired, select a destination (e.g., personal feed, group chat, story), and then trigger publication with one or a few taps.

Upon user confirmation, the approved artifact is routed to the appropriate social destination 530 (e.g., feed, story, private message thread, group) through the social session manager 120. The provenance and audit module 390 records the publication event, including which corpus segments were used to generate the original response, the validation outcome, and any user modifications made prior to publication.

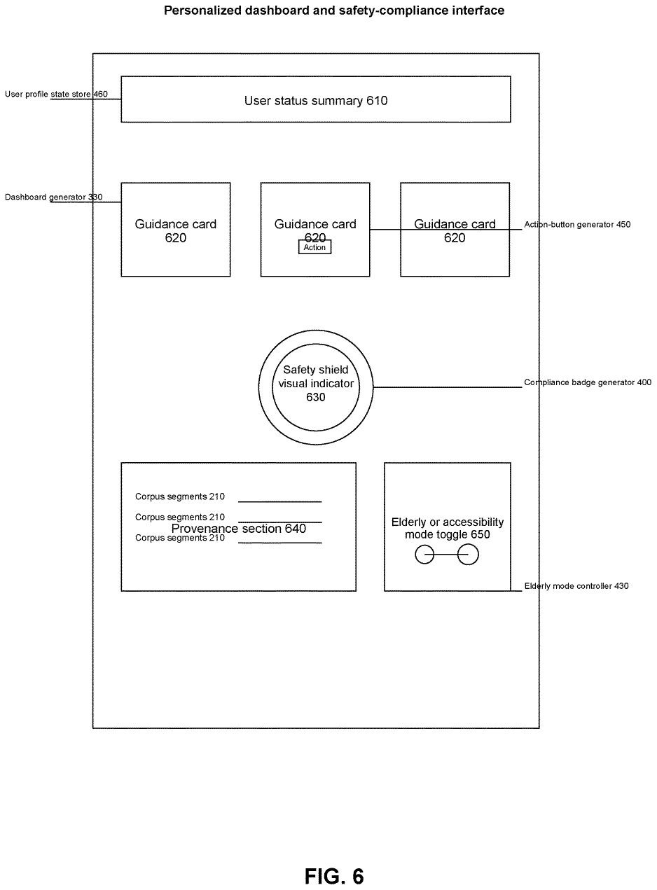

### VII. Personalized Dashboard and Safety Compliance (FIG. 6)

Referring now to FIG. 6, a personalized dashboard and safety-compliance interface is illustrated. This dashboard, generated at least in part by dashboard generator 330 and compliance badge generator 400, provides the user with a consolidated view of AI-generated guidance, system status, and assurance of content fidelity.

The dashboard may be accessed via a dedicated tab within the social interface or may appear as a summary panel after an AI interaction. The dashboard comprises several visual components, each with a specific function.

A user status summary 610 presents a high-level overview of the user's recent interactions with the AI system. This may include a count of questions asked, topics explored, or guidance received. In some embodiments, the user status summary 610 includes personalized metrics derived from the user profile state store 460, such as areas of interest or recurring concerns.

One or more guidance cards 620 are displayed, each representing a validated response that has been transformed into a user-specific visual indicator. For example, a guidance card 620 may contain a succinct answer to a previously asked question, a recommended next step, or a daily insight drawn from the authoritative axiom corpus. Action-button generator 450 may attach interactive buttons to each guidance card 620, enabling the user to take immediate action, such as “Learn More,” “Apply This to My Plan,” or “Share This.”

A safety shield visual indicator 630 is prominently displayed. This indicator, generated by compliance badge generator 400, provides the user with immediate visual confirmation that the content presented in the dashboard has passed the fidelity validation stage and complies with the safety axioms contained within the authoritative axiom corpus store 200. The safety shield visual indicator 630 may be a badge, an icon, or a color-coded status bar, and its presence signifies that the displayed guidance is traceable to the authoritative corpus and has not been hallucinated or derived from unverified sources.

A provenance section 640 may optionally be displayed, providing the user with transparency into the source of the guidance. For example, the provenance section 640 may list the specific corpus segments 210 that were retrieved to generate a particular answer, allowing the user to verify the basis of the guidance.

An elderly or accessibility mode toggle 650 may be present, allowing the user to quickly enable the adaptations managed by elderly mode controller 430, including enlarged controls, high-contrast UI, and simplified-language rendering.

The dashboard of FIG. 6 serves as a trust anchor within the H App ecosystem, reassuring users that the AI assistance they receive is not arbitrary or probabilistic but is grounded in a verifiable, authoritative, and safety-compliant knowledge base.

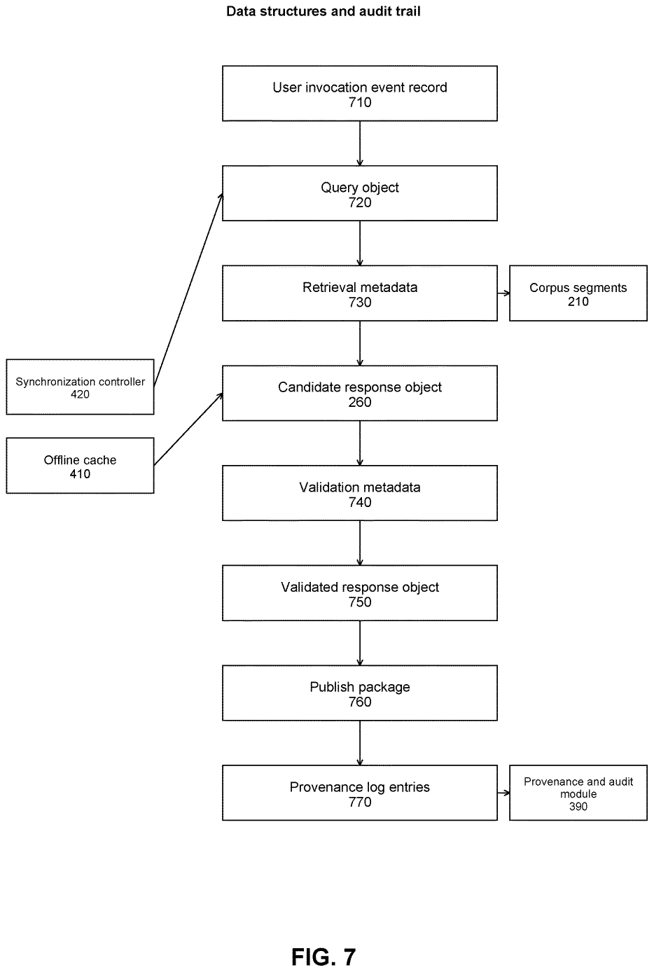

### VIII. Data Structures and Audit Trail (FIG. 7)

Referring now to FIG. 7, a data-structure diagram illustrates the key data objects and their relationships that enable the provenance and audit capabilities of the system. The provenance and audit module 390 relies on structured data to log interactions, support transparency, and facilitate compliance reporting.

The diagram shows a user invocation event record 710, which is created each time a user invokes the AI invocation interface 140. The user invocation event record 710 includes fields such as a unique event identifier, a user identifier, a timestamp, the type of invocation (e.g., tap on floating Ask AI control 150, voice wake phrase), and the social context at the time of invocation (e.g., feed position, active chat thread). This record establishes the beginning of an AI interaction session.

A query object 720 is created by input processor 160 after the user submits a query. The query object 720 contains the raw text of the query (as typed or transcribed by speech-to-text engine 170), a normalized version of the query produced by text query parser 180, and optionally a language identifier or other metadata.

Retrieval metadata 730 is generated by retrieval controller 220 during the retrieval stage. This metadata records which corpus segments 210 were retrieved in response to the query. For each retrieved segment, the metadata may include a segment identifier, a relevance score, and the version of the authoritative axiom corpus used. This information provides a direct link between the user's query and the source material used to generate the answer.

A candidate response object 260 is generated by response-generation engine 250. As previously described, this object contains the raw generated text and any structured formatting instructions. The candidate response object 260 is associated with the query object 720 and the retrieval metadata 730.

Validation metadata 740 is produced by fidelity validator 270 after evaluating the candidate response object 260. This metadata includes a fidelity score computed by support-score engine 280, an indication of whether any contradictions were detected by contradiction detector 290, and a final validation decision (e.g., approved, rejected, revised). The validation metadata 740 is linked to the candidate response object 260.

A validated response object 750 is the output of the fidelity validation stage. It contains the final text, formatting, and any annotations applied during validation. The validated response object 750 is associated with the validation metadata 740.

A publish package 760 is created when the user elects to publish content via multimodal publishing pipeline 340. The publish package 760 includes the final published artifact (e.g., a post, a video file, a message), a reference to the validated response object 750 from which it was derived, and any user modifications captured during the preview stage. The publish package 760 also records the destination of the publication (e.g., feed, group chat).

Provenance log entries 770 aggregate the records described above into a unified, time-sequenced log. The provenance and audit module 390 writes provenance log entries 770 to a persistent storage system. These entries may be used for audit purposes, for generating transparency reports to users, for compliance with regulatory requirements, or for debugging and improving the AI pipeline.

An offline cache 410 is also depicted, storing selected corpus fragments 210, query templates, prior validated responses 750, or publish packages 760 that have been queued for synchronization. Synchronization controller 420 manages the upload and download of data between offline cache 410 and remote servers when connectivity is restored.

The structured data approach illustrated in FIG. 7 ensures that every AI-assisted interaction and publication event within the H App is fully traceable, verifiable, and auditable. This technical capability distinguishes the platform from conventional social and AI systems, providing a foundation of trust and accountability.

### IX. Technical Advantages and Improvements

The present invention provides numerous technical advantages over conventional systems and methods for social and artificial-intelligence interaction.

First, the invention substantially reduces context-switching overhead. By maintaining the AI invocation interface 140 as an always-available overlay within the social session, users are not required to exit the social application, navigate to a separate chatbot or search tool, and then manually return. The session context buffer 190 preserves the user's position, minimizing cognitive disruption and improving overall user efficiency.

Second, the invention improves the reliability and trustworthiness of AI-generated content within a social environment. The combination of retrieval controller 220 restricted to an authoritative axiom corpus store 200 and fidelity validator 270 ensures that generated responses are grounded in a verifiable source of truth. The support-score engine 280 and contradiction detector 290 provide technical safeguards against hallucinations and unsupported claims. This represents a significant improvement over conventional AI chatbots, which may generate plausible-sounding but factually incorrect or unverified information.

Third, the invention enhances accessibility for elderly, low-literacy, and non-technical users. The voice-first interaction mode depicted in FIG. 4, combined with elderly mode controller 430, simplified-language renderer 310, and text-to-speech engine 320, reduces barriers to entry. Users can receive complex, axiom-based guidance through simple spoken dialogue, without needing to read lengthy documents or navigate complex menus.

Fourth, the invention accelerates the content creation and sharing cycle. The multimodal publishing pipeline 340 enables users to transform a validated response into a publishable social artifact—such as a post, video, or message—with one or a few actions, all within the same application session. This seamless integration encourages user engagement and facilitates the rapid dissemination of authoritative information through social networks.

Fifth, the invention provides a verifiable audit trail and provenance framework. The provenance and audit module 390, together with the data structures depicted in FIG. 7, allows the system to log and retrieve a complete record of each AI interaction and publication event. This capability supports transparency, compliance, and continuous improvement of the AI models and retrieval systems.

Sixth, the invention provides a platform for delivering personalized, life-critical guidance at scale. By constraining responses to an authoritative axiom corpus that addresses work, education, family, health, and future planning, the system can provide millions of users with consistent, high-quality guidance tailored to their individual queries, while maintaining strict fidelity to the underlying corpus.

These technical advantages collectively represent a substantial improvement in the field of computer-implemented social and artificial-intelligence platforms.

### X. Additional Embodiments, Variations, and Implementation Flexibility

In additional embodiments, one or more modules described herein may be implemented as client-side application logic, server-side microservices, edge-executed services, cloud-native containers, or hybrid on-device and remote processing components, provided that the system preserves the unified social-session interaction model described herein.

In further embodiments, the validation operation may be performed before generation, during generation, after generation, or in multiple stages, including a first pass that enforces corpus-bounded answer generation and a second pass that applies support scoring, contradiction detection, traceability checks, or compliance marking prior to rendering or publication.

In further embodiments, the publishing pipeline may generate a preview package before final publication, and the preview package may include a draft post, draft message, draft story artifact, draft short-form video, draft subtitle track, draft overlay, or any combination thereof, thereby permitting one-click or reduced-step publication after user confirmation.

In further embodiments, the response-generation engine may generate plain-text answers, synchronized text-and-audio answers, graphical card layouts, dashboards, short-form videos, subtitles, infographics, overlays, or combinations thereof, and the multimodal publishing pipeline may transform a single validated response into multiple destination-specific artifacts within the same active application session.

In further embodiments, the system may operate in an online mode, a partially offline mode, or a reduced-connectivity mode in which selected corpus fragments, prompts, validated responses, or publication drafts are cached locally and synchronized when connectivity is restored.

In further embodiments, the social interface may comprise a feed, a vertical short-video interface, a private chat, a group chat, a comment thread, a live-stream interface, a story interface, a group page, an event page, or a social information stream, and artificial-intelligence invocation may be provided through a floating control, a toolbar control, a long-press region, a gesture, a microphone-enabled one-tap control, or a wake phrase.

### XI. Claim-Scope Support and Reference-Numeral Consistency

For avoidance of doubt, identical reference numerals used throughout the present specification and the associated drawings refer to corresponding elements, modules, objects, stages, records, packages, or controllers, unless expressly stated otherwise. The applicant intends that each reference numeral appearing in the figures be supported by corresponding descriptive text in the specification, and each reference numeral described in the specification be depicted in at least one associated figure.

Unless expressly stated otherwise, references to a system, platform, module, engine, controller, store, interface, generator, validator, renderer, pipeline, adapter, package, badge, record, object, stage, or controller encompass implementations using one component, multiple components, distributed components, functionally equivalent structures, or software-defined services configured to perform the recited function.

Unless expressly stated otherwise, references to text, speech, audio, video, multimodal content, cards, dashboards, overlays, subtitles, messages, posts, stories, artifacts, previews, or publish packages encompass one or more corresponding media forms, encodings, presentation formats, or destination-specific renderings.

Unless expressly stated otherwise, references to an authoritative corpus, authoritative axiom corpus, bounded corpus, corpus segment, structured knowledge base, or designated source of truth encompass searchable, indexable, retrievable, or otherwise referenceable data collections suitable for grounding, constraining, supporting, validating, annotating, or compliance-checking artificial-intelligence output.

XII. Enablement, Written Description, and Equivalent Implementations

The present specification describes representative system architectures, user-interface flows, retrieval pipelines, validation operations, publishing workflows, voice-first interaction modes, dashboard embodiments, audit-trail structures, and accessibility embodiments sufficient to inform a person of ordinary skill in the art how to make and use the claimed invention without undue experimentation.

The present disclosure further demonstrates possession of the claimed subject matter by describing, in figure-by-figure and component-by-component detail, the relationships among the social session manager, session context buffer, AI invocation interface, authoritative axiom corpus store, retrieval controller, embedding and similarity engine, prompt assembly module, response-generation engine, fidelity validator, support-score engine, contradiction detector, output renderer, multimodal publishing pipeline, dashboard generator, compliance badge generator, provenance and audit module, offline cache, synchronization controller, and associated data objects.

Features described in connection with one embodiment may be used in connection with another embodiment unless inconsistent therewith. Steps described as sequential may, where appropriate, be performed in series, in parallel, in a streaming pipeline, iteratively, conditionally, or continuously. The invention is not limited to the specific embodiments expressly described, and modifications, substitutions, combinations, subcombinations, rearrangements, and equivalents may be employed without departing from the spirit and scope of the appended claims.

What is claimed is:

1. A computer-implemented hybrid social-artificial-intelligence interaction system, comprising:
(a) a social session manager configured to maintain an active user session in a social interface, wherein the social interface comprises at least one of a vertical short-video feed, a real-time discussion feed, a private chat, a group chat, a comment thread, a live-stream interface, a story interface, a group page, or an event page; and optionally a feed, a vertical short-video interface, or a social information stream generated from content received from multiple user devices; (b) an invocation interface configured to receive a user command to invoke artificial-intelligence assistance without exiting said social interface, including through a persistent floating control or microphone-enabled one-tap control; (c) an input processor configured to receive a user query in text, speech, or both, and optionally a user prompt or intent query; (d) a corpus store comprising an authoritative axiom corpus, wherein the authoritative axiom corpus is a bounded sole-authority corpus for at least one response mode such that generated answers in said response mode are constrained to derived content supported by said corpus, and optionally a structured civilizational knowledge base storing structured axiom data representing deterministic principles associated with future human-civilizational states; (e) a retrieval controller configured to retrieve one or more corpus segments from said corpus store responsive to said user query, and optionally to route said user query to a cognitive artificial-intelligence engine; (f) a response-generation engine configured to generate a candidate response using at least said user query and said one or more corpus segments, including, in some embodiments, a deterministic answer, text content, video content, or one-click AI content generation based on natural-language user prompts; (g) a fidelity validator configured to evaluate whether said candidate response satisfies one or more faithfulness criteria with respect to said one or more corpus segments or said authoritative axiom corpus, including, in some embodiments, traceability criteria, symbolic-consistency criteria, or axiom-compliance criteria, and to reject, revise, annotate, confidence-score, or compliance-mark output not traceable to said corpus; (h) an output renderer configured to render a validated response within said social interface, including, in some embodiments, text, synchronized speech, graphical cards, dashboards, visual indicators, action lists, or preview content; (i) a publishing pipeline configured to convert at least part of said validated response into a publishable social artifact within the same application session, including one-click community posting of AI-generated text or video without leaving the social interface, optionally after display of a preview pane; wherein the system is configured to perform, within the active user session and without exiting the social interface, the steps of: receiving the user query, retrieving the one or more corpus segments, generating the candidate response, validating the candidate response, rendering the validated response, and publishing the publishable social artifact.

2. A computer-implemented method for hybrid social-artificial-intelligence interaction, comprising:
(a) maintaining a user inside an active social session or social information-stream interface;
(b) receiving, during said active social session, an invocation of an artificial-intelligence assistant, including through text input, speech input, or an Ask AI control;
(c) receiving a user query without forcing said user to exit said active social session, wherein the user query may comprise a user prompt or intent query;
(d) retrieving one or more corpus segments from an authoritative corpus responsive to said user query, or from a structured civilizational knowledge base responsive to said user query;
(e) generating a candidate response using at least said user query and said one or more corpus segments, including, in some embodiments, routing said user query through an interaction router to a cognitive artificial-intelligence engine and generating a deterministic answer, AI-generated text content, AI-generated video content, or both, under one or more fidelity-enforcement prompts;
(f) validating said candidate response for faithfulness to said authoritative corpus, including, in some embodiments, support, contradiction status, symbolic consistency, or axiom compliance relative to said authoritative corpus, including real-time axiom compliance checking during generation and publishing workflows;
(g) rendering a validated response inside said active social session;
(h) selectively converting said validated response into a publishable social artifact in said same application session, wherein the step of generating further comprises generating a user-specific guidance package responsive to a personal-life query concerning work, education, family, inheritance, health, or future planning, including, in some embodiments, one-click generation of text or short-form video and one-click posting to a feed, chat, group, story, or community interface, optionally after display of a preview, and optionally integrating said validated response or said publishable social artifact into said social information stream to preserve seamless social interaction in a unified user interface.

3. A non-transitory computer-readable medium storing instructions that, when executed by one or more processors, cause the one or more processors to perform operations for hybrid social-artificial-intelligence interaction, the operations comprising:
(a) maintaining a user inside an active social session or inside a social interface while artificial-intelligence assistance remains continuously available;
(b) receiving, during said active social session, an invocation of an artificial-intelligence assistant;
(c) receiving a user query without forcing said user to exit said active social session, wherein the user query may comprise a user prompt, intent query, text input, speech input, or mixed modality input;
(d) retrieving one or more corpus segments from an authoritative corpus responsive to said user query, or from an authoritative axiom corpus or structured civilizational knowledge base;
(e) generating a candidate response using at least said user query and said one or more corpus segments, including AI-generated text, AI-generated short-form video, or both;
(f) validating said candidate response for faithfulness to said authoritative corpus, including corpus fidelity, traceability, symbolic consistency, support score, contradiction indicator, or axiom compliance;
(g) rendering a validated response inside said active social session, including text, speech, dashboard content, or preview media within said same social interface;
(h) selectively converting said validated response into a publishable social artifact in said same application session, including seamless one-click publication of said validated output as a post, message, story artifact, community item, or short-form video within the same application session, and optionally supporting voice duplex interaction, simplified-language delivery, offline caching, provenance logging, visible safety or compliance badge integration, or execution on a mobile terminal having system-level permissions or preinstalled artificial-intelligence smartphone functionality.

4. The system of claim 1, wherein said invocation interface comprises a persistent floating control displayed over said social interface.

5. The system of claim 1, wherein said input processor comprises a speech-to-text engine configured to transcribe spoken input in real time while said user remains in said social interface.

6. The system of claim 1, wherein said output renderer comprises a text-to-speech engine configured to deliver spoken output while concurrently displaying synchronized text and wherein the voice interaction controller is configured to support continuous duplex interaction including playback pause, replay, variable-speed playback, or wake-phrase activation.

7. The system of claim 1, wherein said fidelity validator is configured to reject, revise, annotate, or confidence-score said candidate response when said candidate response is insufficiently supported by retrieved corpus segments.

8. The system of claim 1, wherein said publishing pipeline is configured to generate, from said validated response, at least one of: a short post, a long-form post, a direct-message reply, a group-message reply, a story card, a short-form narrated video, a subtitle track, a live-stream overlay, or an infographic panel and wherein the publishing pipeline is further configured to automatically generate a short-form video that includes synthesized narration, captions, and one or more visual elements derived from said validated response.

9. The system of claim 1, further comprising a simplified-language renderer configured to transform said validated response into a readability-adjusted format suitable for a low-literacy or non-technical user.

10. The system of claim 1, further comprising a voice interaction controller configured to support continuous duplex interaction including playback pause, replay, variable-speed playback, or wake-phrase activation.

11. The system of claim 1, further comprising a dashboard generator configured to convert said validated response into one or more user-specific visual indicators, guidance cards, or action lists and wherein the dashboard generator is further configured to display a safety shield visual indicator verifying compliance with one or more safety axioms from the authoritative axiom corpus.

12. The system of claim 1, wherein the fidelity validator comprises a support-score engine to determine whether propositions in the candidate response are sufficiently supported by the retrieved one or more corpus segments and a contradiction detector configured to identify statements in the candidate response that conflict with the authoritative axiom corpus.

13. The method of claim 2, wherein step (c) comprises receiving speech input and displaying incremental transcription while a feed, video, or chat remains visible in the background.

14. The method of claim 2, wherein step (f) comprises computing a fidelity score, a support score, or a contradiction indicator relative to said authoritative corpus.

15. The method of claim 2, wherein step (h) comprises automatically generating a short-form video that includes synthesized narration, captions, and one or more visual elements derived from said validated response.

16. The method of claim 2, wherein step (h) further comprises presenting a one-tap control for posting said publishable social artifact to a feed, chat, group, or story interface.

17. The method of claim 2, further comprising generating a user-specific guidance package responsive to a personal-life query concerning work, education, family, inheritance, health, or future planning.

18. The system of claim 1, further comprising an offline cache configured to store selected corpus fragments, prompts, or prior validated responses for use during reduced-connectivity conditions.

19. The system of claim 1, further comprising a provenance and audit module configured to record at least one of: user invocation events, retrieval references, validation outcomes, publication events, or content-transformation steps.

20. The system of claim 1, wherein the output renderer further comprises an elderly mode controller that is configured to apply one or more adaptations including: enlarged controls, high-contrast UI, simplified-language transformation, slower speech output, automatic repeat prompts, or voice-only navigation and wherein the system is further configured to provide a visual preview of AI-generated content before one-click publishing and to apply axiom-based quality filtering to promote valuable content while maintaining high engagement.
